(19) United States
(12) Patent Application Publication
(10) Pub. No.: US 2021/0270987 A1
(43) Pub. Date: Sep. 2, 2021

(54) METHOD FOR CREATING STATISTICS ON CONTENT OF ROCK DEBRIS IN CONGLOMERATE RESERVOIR

(71) Applicant: CHINA UNIVERSITY OF PETROLEUM (EAST CHINA), Qingdao (CN)

(72) Inventors: Xiyu QU, Qingdao (CN); Yangchen ZHANG, Qingdao (CN); Xiutian YAO, Qingdao (CN); Weiming WANG, Qingdao (CN); Longwei QIU, Qingdao (CN)

(21) Appl. No.: 17/326,296

(22) Filed: May 20, 2021

Related U.S. Application Data
(63) Continuation of application No. PCT/CN2019/092904, filed on Jun. 26, 2019.

(30) Foreign Application Priority Data
Apr. 17, 2019 (CN) 201910309461.X

(51) Int. Cl. G01V 1/46; G01V 1/50

(52) U.S. Cl. CPC G01V 1/46; G01V 1/50

(57) ABSTRACT

A method includes: capturing an imaging well log according to a research depth; processing imaging well log to acquire an area percentage of total content of gravel components; selecting a rock core sample, and obtaining area content percentages of various kinds of gravel-grade rock debris in a rock core section sample; obtaining final percentage content of each kind of gravel-grade rock debris according to area content percentages of various kinds of gravel-grade rock debris and the area percentage of the total content of the gravel components; acquiring content of various kinds of sand-grade rock debris in the rock core sample corresponding to research depth; and adding final percentage content of the various kinds of gravel-grade rock debris and the content of the same kinds of sand-grade rock debris so as to obtain actual content percentages of various kinds of rock debris at the research depth.

### CROSS-REFERENCE TO RELATED APPLICATIONS

The present application is a continuation of PCT application PCT/CN2019/092904 entitled “Method for creating statistics on content of rock debris in conglomerate reservoir” filed on Jun. 26, 2019, which claims priority of Chinese patent application CN201910309461.X, filed on Apr. 17, 2019, the entire contents of which are incorporated herein by reference.

### TECHNICAL FIELD

The present invention relates to the field of quantitative characterization of reservoir petrology in the research of conglomerate reservoirs, in particular to a method for creating statistics on the content of rock debris in a conglomerate reservoir.

### BACKGROUND

Rock debris, fragments of a parent rock, is a mineral aggregate for keeping the structure of the parent rock. A sedimentary facies belt of the conglomerate reservoir changes rapidly, the reservoir heterogeneity is strong, and rock components are complicated. The type of rock debris not only includes a gravel grade, but also includes a sand grade. Quantitative statistics for the rock debris plays an active role in discriminating compositional maturity of the reservoir and nature of the parent rock in a source area as well as making a deeper research, including main control factors affecting the physical property of the reservoir and a reservoir formation and evolution mechanism. Therefore, the quantitative statistics for the rock debris is an essential part of the reservoir research. Due to complicated structural fabric of conglomerate rock, the method for accurately and quantitatively characterizing the content of rock debris in the conglomerate reservoir must be studied.

### SUMMARY

When the lithological characteristics of a conglomerate reservoir are studied in the prior art, the quantitative statistics is usually conducted for different kinds of rock debris based on the size of a slice under the microscope, but the quantitative statistics for the gravel-grade rock debris is ignored macroscopically, thereby causing errors on the content of rock debris. Due to complicated rock composition of the conglomerate reservoir, conglomerate and sandstone are usually mingled, the content of rock debris counted up by virtue of a method for using the thin section identification alone can only represent the content of rock debris in the sandstone, but cannot represent the content of gravel-grade rock debris in the whole conglomerate reservoir.

The present invention aims to: with respect to the existing problems, provide a method for creating statistics on the content of rock debris in a conglomerate reservoir, which precisely characterizes the contents of different kinds of rock debris in the conglomerate reservoir by combining the content of sand-grade rock debris and the content of gravel-grade rock debris.

The technical solution of the present invention is as follows:

a method for creating statistics on the content of rock debris in the conglomerate reservoir, comprising the following steps:

a. capturing a corresponding imaging well log according to a required research depth;

b. processing the imaging well log to acquire an area percentage Nrock debris (total) of the total content of gravel components at the research depth;

c. selecting a rock core sample corresponding to the research depth, and obtaining area content percentages Qrock debris X of various kinds of gravel-grade rock debris in a rock core section sample, wherein the rock debris X expresses various kinds of rock debris;

d. obtaining the final percentage content Mrock debris X (gravel-grade) of each kind of gravel-grade rock debris according to the area content percentages of the various kinds of gravel-grade rock debris and the area percentage of the total content of the gravel components, wherein the Mrock debris X (gravel-grade)=Qrock debris X x Nrock debris (total);

e. taking a sandstone sample for the rock core sample corresponding to the research depth to prepare a thin section, so as to acquire the content Qrock debris X (sand-grade) of various kinds of sand-grade rock debris by virtue of a point estimate method; and

f. adding the final percentage content Mrock debris X (gravel-grade) of the various kinds of gravel-grade rock debris and the content Qrock debris X (sand-grade) of the same kinds of sand-grade rock debris to obtain actual content percentages of various kinds of rock debris at the research depth.

Further, the step b is specifically as follows:

b1. carrying out full-borehole processing on the imaging well log to eliminate white bar parts, and smoothing;

b2. marking bright spots of the gravel in the imaging well log to obtain areas of various bright spots due to the fact that the gravel in the conglomerate, with the characteristics of low gamma and potassium content as well as high thorium content and electrical resistivity, is in bright white or bright yellow and is mainly massive and porphyritic in structure: specifically,

b2.1: converting the imaging well log into a gray image from a colorful image;

b2.2: converting the gray image into a binary image based on the brightness;

b2.3: deleting targets less than 100 pixels from the binary image; and

b2.4: finding out a bright spot boundary in the processed binary image, and calculating the areas of the various bright spots after the bright spot boundary is drawn;

b3. adding the areas of the various bright spots to obtain a total area of the bright spots, and making a ratio of the total area of the bright spots to the total area of the imaging well log to acquire an area percentage Nrock debris (total) of the total content of gravel components.

Further, step c is specifically as follows:

c1. obtaining the type of the gravel-grade rock debris through the rock core sample;

c2. measuring particle sizes of various kinds of gravel-grade rock debris, and calculating the area of the rock debris, specifically including processes that for an elongated rock debris particle with a ratio of a long axis length to a short axis length more than or equal to 1.5, the long and short axes of the particle are measured, and then an ellipse area formula is utilized to approximately obtain an actual area of the elongated particle, namely the area of the rock debris is Sellipse=nab, where a is the length of a semi-major axis of the rock debris particle, and b is the length of a semi-minor axis of the rock debris particle. For circular rock debris particles in case of little difference between the long and short axes of the particle, namely the ratio of the length of the long axis to the length of the short axis being greater than or equal to 1 but smaller than 1.5, the particle may be seen as a circle approximately, using the circle area formula to approximately obtain the actual area of such particle, namely the area of the rock debris is Scircle=πR2, where R is the length semi-diameter of the long axis of the rock debris particle;

c3. adding the areas of all kinds of gravel-grade rock debris to obtain the total area of rock debris Srock debris (total);

c4. classifying the areas of all measured rock debris one by one according to the types of rock debris thereof; adding the areas of various kinds of gravel-grade rock debris to obtain the total area Srock debris X of various kinds of rock debris;

c5. obtaining the area Qrock debris X=Srock debris X/Srock debris (total) of various kinds of gravel-grade rock debris.

In conclusion, with the foregoing technical solution according to the present invention, the type of rock debris in a target horizon of a research area in terms of the rock core and the thin section is divided in details, and then the contents of the macroscopic gravel-grade rock debris and the microscopic sand-grade rock debris are combined to further improve upper and lower limit values of the total content of rock debris and the content of various kinds of rock debris in the conglomerate reservoir. According to the method for creating statistics on the rock debris proposed in the present invention, the type of rock debris in the research area is divided comprehensively and exhaustively, and meanwhile, the statistical range of the content of rock debris in the conglomerate reservoir gets more comprehensive and accurate, thereby providing the later research on the reservoir with a more scientific data support.

### BRIEF DESCRIPTION OF DRAWINGS

FIG. 1 is a flow chart according to the present invention.

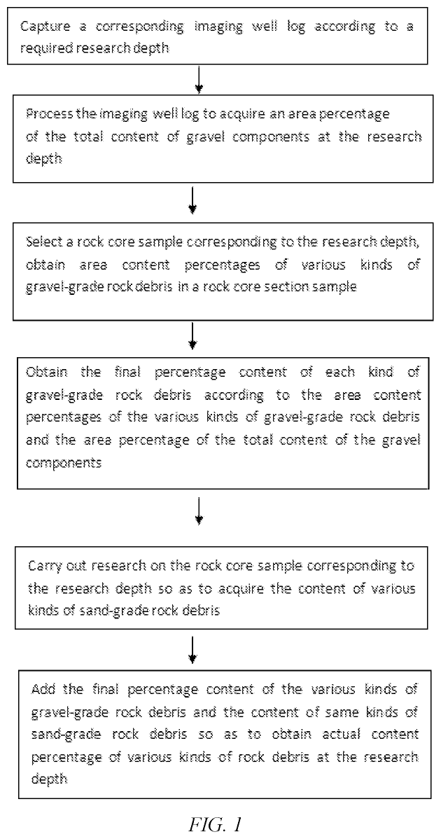

### DETAILED DESCRIPTION OF THE EMBODIMENTS

All features disclosed in the Description can be combined by any means, except combinations of such features and/or steps as are mutually exclusive.

A new method for creating statistics on the content of rock debris in a conglomerate reservoir, comprising the following steps that:

First, a rock core sample is selected from Yan 22-22 Well in the north zone of Dongying Depression, the selected depth section is 3688.00 m-3695.50 m of the upper sub-member of Sha-IV formation, specific depth points are 3691.25 m and 3692.45 m, and the lithology is sandy conglomerate. The rock core sample in Yong'an Block is selected from Yong 559 Well, and the specific coring positions of the Yong 559 Well are 3225.8 m, 3226 m and 3226.45 m of the upper sub-member of Sha-IV formation.

Considering the identification accuracy of the gravel content, depth sections with a spacing between front and rear depth points of about 1 m (including the two depth points) are selected with regard to the depth points of the rock core sample, actually the two depth sections of 3691 m-3692 m and 3692 m-3693 m; and then the imaging well log of the 3691 m-3692 m depth section m is extracted from the collected imaging well log. Full-borehole processing is conducted for the imaging well log to eliminate white bar parts, followed by smoothing; the bright spots of the gravel in the selected imaging well log are marked and delineated to obtain an area of every bright spot by virtue of an algorithm routine operated and edited by MATLAB software; the areas of all bright spots are summated, and a ratio of the sum to the total area of imaging well log is made in order to acquire an area percentage of the total content of gravel components of such depth section. Processing the three depths of 3225.5-3226.5 m, 3226.5-3227.5 m and 3325-3326 m of Yong 559 Well to acquire the area percentage of the total content of gravel components depending on the same method is as follows:

TABLE 1
Identification Results of Gravel Contents

| | | | Design | | Design | | Identification |
|---|---|---|---|---|---|---|---|
| | Depth | | top | | bottom | | result of |
| Well No. | point | | depth | | depth | | gravel content |
| Yan 22-22 | 3691.25 | m | 3691 | m | 3692 | m | 7.48% |
| Well | 3692 | m | 3693 | m | 3692.45 | m | 7.46% |
| Yong 559 | 3226 | m | 3225.5 | m | 3226.5 | m | 13.75% |
| Well | 3226.45 | m | 3226.5 | m | 3227.5 | m | 18.15% |
| | 3325.8 | m | 3325 | m | 3326 | m | 11.84% |

The type of the gravel-grade rock debris in the rock core sample is obtained with respect to the selected rock core sample, and gravel-grade carbonatite debris, silicalite debris, granitics gneiss debris and pelite debris are identified from the rock core sample at the 3691-3693 m depth section of Yan 22-22 Well. The gravel-grade carbonatite debris, the silicalite debris and the granitics gneiss debris are identified from the rock core sample at the 3226-3227 m depth section of Yong 559 Well. Particle sizes of various kinds of gravel-grade rock debris are measured, and the area of the rock debris is calculated; for an elongate rock debris particle with a ratio of the length of a long axis to the length of a short axis more than or equal to 1.5, the long and short axes of the particle are measured, and then an ellipse area formula is utilized to approximately obtain an actual area of such particle, namely the area of rock debris is Sellipse=nab, where a is the length of a semi-major axis of the rock debris particle, and b is the length of a semi-minor axis of the rock debris particle; in case of little difference between the long and short axes of the particle, namely the ratio of the length of the long axis to the length of the short axis is greater than or equal to 1 but smaller than 1.5, the particle may be seen as a circle approximately, the circle area formula is utilized to be approximately obtain the actual area of such particle, namely the area of the rock debris is Scircle=πR2, where R is a length semi-diameter of the long axis of the rock debris particle;

The final percentage content Mrock debris X (gravel-grade) of each kind of gravel-grade rock debris is obtained according to the area content percentages of the various kinds of gravel-grade rock debris and the area percentage of the total content of the gravel components, wherein Mrock debris X (gravel-grade)=Qrock debris X x Nrock debris (total), so as to obtain an actual content of the gravel-grade rock debris of each sample. The gravel-grade carbonatite debris, silicalite debris, granitics gneiss debris and pelite debris are identified from the rock core sample at the 3691-3693 m depth section of Yan 22-22 Well, wherein an average content of carbonatite debris is about 3.62%, an average content of silicalite debris is about 1.24%, an average content of granitics gneiss debris is about 2.88%, and an average content of pelite debris is about 0.73%. The gravel-grade carbonatite debris, the silicalite debris and the granitics gneiss debris are identified from the rock core sample at the 3226-3227 m depth section of Yong 559 Well, wherein an average content of silicalite debris is about 11.26%, an average content of granite debris is 2.41%, and an average content of pelite debris is 0.31%.

A sandstone sample is taken for the rock core sample corresponding to the research depth to prepare a thin section, so as to identify various kinds of sand-level rock debris on the thin section and acquire the content of various kinds of sand-grade rock debris. A combination type of rock debris is divided into 3 categories and 8 subcategories. The three categories mainly include sedimentary rock debris, magmatic rock debris and metamorphic rock debris, wherein the sedimentary rock debris includes pelite debris, carbonatite debris (limestone and dolomite) and sandstone debris; the magmatic rock debris includes granite debris and acidic extrusive rock debris; and the metamorphic rock debris includes metaquartzite debris, granitics gneiss debris and phyllite debris. The statistical results of the content of various sand-grade rock debris in the research area are as follows. At the 3691-3693 m depth section of Yan 22-22 Well, an average content of silicalite debris is 7.16%, an average content of carbonatite debris is 10.89%, an average content of granitics gneiss debris is 13.7%, an average content of pelite debris is about 2.02%, and the content of remaining debris is low and negligible; at the 3226-3227 m depth section of Yong 559 Well, an average content of silicalite debris is about 16.06%, an average content of carbonatite debris is about 2.38%, an average content of granite debris is about 4.45%, and an average content of granitics gneiss debris is about 26.71%. The results are shown in the table below:

TABLE 2
Statistical Results of Contents of Rock Debris of Some Wells in Upper
Sub-Member of Sha-IV Formation of Yanjia-Yong'an Area in the North Zone of Dongying
Depression

| | | | | | | | | | | | | | Actual statistical | Actual statistical | |
|---|---|---|---|---|---|---|---|---|---|---|---|---|---|---|---|
| | | | | | | | | | | | | | number | number | |
| | | | | Particle | | | | | Content of | | Content of | | of | of | |
| | | | | size | Content of | Content of | Content of | Content of | phyllite | Content of | acidic | Content of | rock | skeleton | Total |
| | | | | range of | silicalite | carbontite | granite | granitics gneiss | debris | sandstone | extrusive | pelite | debris | particles | content |
| Work | Target | | | rock | debris | debris | debris | debris | (%) | debris | rock debris | debris | under the | under the | of rock |
| area | horizon | Well No. | Depth (m) | debris | (%) | (%) | (%) | (%) | (%) | (%) | (%) | (%) | microscope | microscope | debris (%) |
| Yanjia | Upper sub- | Yan | 3691.35 | Gravel-grade | 1.39 | 4.13 | | 2.96 | | | | 0.98 | | | 56.24 |
| Block in | member | 22- | | rock | | | | | | | | | | | |
| the North | of | 22 | | debris | | | | | | | | | | | |
| zone of | Sha-IV | Well | | Sand-grade | 7.82 | 18.58 | 0 | 15.67 | 1.22 | | 1.11 | 2.38 | 224 | 313 | |
| Dongying | formation | | | rock | | | | | | | | | | | |
| Depression | | | | debris | | | | | | | | | | | |
| | | | 3692.45 | Gravel-grade | 1.08 | 3.11 | | | | | | 0.47 | | | 33.83 |
| | | | | rock | | | | | | | | | | | |
| | | | | debris | | | | | | | | | | | |
| | | | | Sand-grade | 6.49 | 3.19 | 2 | 11.73 | | 1.33 | 0.45 | 1.66 | 204 | 301 | |
| | | | | rock | | | | | | | | | | | |
| | | | | debris | | | | | | | | | | | |
| Yong'an | Upper sub- | Yong 559 | 3226 | Gravel-grade | 8.42 | | 2.43 | 7.06 | | | | 0.22 | | | 6894 |
| Block in | member | Well | | rock | | | | | | | | | | | |
| the North | of | | | debris | | | | | | | | | | | |
| Zone of | Sha-IV | | | Sand-grade | 13.96 | 2.53 | 4.45 | 28.89 | | 0.67 | 0.64 | | 160 | 315 | |
| Dongying | formation | | | rock | | | | | | | | | | | |
| Depression | | | | debris | | | | | | | | | | | |
| | | | 3226.45 | Gravel- | 14.09 | | 2.39 | 1.28 | | | | 0.38 | | | 68.5 |
| | | | | grade | | | | | | | | | | | |
| | | | | rock | | | | | | | | | | | |
| | | | | debris | | | | | | | | | | | |
| | | | | Sand- | 18.15 | 2.23 | 4.45 | 24.52 | | | 1.33 | | 163 | 325 | |
| | | | | grade | | | | | | | | | | | |
| | | | | rock | | | | | | | | | | | |
| | | | | debris | | | | | | | | | | | |

The final percentage content Mrock debris X (gravel-grade) of the various kinds of gravel-grade rock debris and the content Qrock debris X (sand-grade) of the same kinds of sand-grade rock debris are added to obtain actual content percentages of various kinds of rock debris at the research depth. For the statistical results, the total content of rock debris in the upper sub-member of Sha-IV formation of Yanjia Block ranges from 34.74% to 73.15%, and the total content of rock debris in the upper sub-member of Sha-IV formation of Yong'an Block ranges from 49.8% to 69.22%. Comparison with the previous related references is shown in the table below:

TABLE 3
Comparison of Statistical Results of Total Content of Rock Debris
of Conglomerate Reservoir in Upper Sub-member of Sha-IV
Formation in Research Area Between Previous and Present
Researches

| | Statistical results of | | |
|---|---|---|---|
| | content of rock debris | | |
| Work area | Present research | Previous studies | Source |
| Yanjia Block in | 34.74%-73.15% | 8%-62% | Reference [1] |
| the North Zone | | 23.25%-36.08% | Reference [2] |
| of Dongying | | About 34% | Reference [3] |
| Depression | | | |
| Yong'an Block | 49.8%-69.22% | 15%-59% | Reference [4] |
| in the North Zone | | 8%-45% | Reference [5] |
| of Dongying | | | |
| Depression | | | |

Reference [1]: Ma Benben, Cao Yingchang and Wang Yanzhong. Genetic Mechanisms and Classified Evaluation of Low Permeability Reservoirs of Es4s in Yanjia Area, Dongying Depression [J], Journal of Central South University (Science and Technology), 2014, 45(12):4277-4291.
Reference [2]: Ma Benben, Cao Yingchang, Wang Yanzhong et al., Relationship Between Lithofacies and Physical Properties of Sandy Conglomerate Reservoirs of Es4s in Yanjia Area, Dongying Depression [J]. Journal of Jilin University (Earth Science Edition), 2015, 45(2): 495-506.
Reference [3]: Zhang Qing. Identification for Effective Reservoirs of Es4s in Yan 222 Block, Dongying Depression [J]. Petroleum Geology and Recovery Efficiency, 2008, 15(4):33-35+38+1.
Reference [4]: Wang Yanhong, Yuan Xiangchun, Wang Xiaowen, et al. Depositional Characteristics of Glutenite Mass of Es4s in Yong 921-920 Blocks, Dongying Depression [J]. Geological Science and Technology Information, 2014, 33(2):86-91+97.
Reference [5]: Cao Gang, Zou Jingyun, Qu Quangong, et al. Analysis of Controlling Factors of Effective Reservoirs in Glutenite Mass of Sha-VI Formation in Yong 1 Block, Dongying Depression [J]. Lithologic Reservoirs, 2016, 28(1):30-37+64.

### INDUSTRIAL APPLICABILITY

By comparing with the previous research results, it can be found that the upper and lower limit values of the total content range of the rock debris obtained by this research method are improved greatly and are more accurate than the previous research results.

What is claimed is:

1. A method for creating statistics on the content of rock debris in the conglomerate reservoir, comprising the following steps:
a. capturing a corresponding imaging well log according to a required research depth;
b. processing the imaging well log to acquire an area percentage Nrock debris (total) of the total content of gravel components at the research depth;
c. selecting a rock core sample corresponding to the research depth, and obtaining area content percentages Qrock debris X of various kinds of gravel-grade rock debris in a rock core section sample, wherein the rock debris X expresses various kinds of rock debris;
d. obtaining the final percentage content Mrock debris X (gravel-grade) of each kind of gravel-grade rock debris according to the area content percentages of the various kinds of gravel-grade rock debris and the area percentage of the total content of the gravel components, wherein the Mrock debris X (gravel-grade)=Qrock debris X x Nrock debris (total);
e. taking a sandstone sample for the rock core sample corresponding to the research depth to prepare a thin section, so as to acquire the content Qrock debris X (sand-grade) of various kinds of sand-grade rock debris by virtue of a point estimate method; and
f. adding the final percentage content Mrock debris X (gravel-grade) of the various kinds of gravel-grade rock debris and the content Qrock debris X (sand-grade) of the same kinds of sand-grade rock debris to obtain actual content percentages of various kinds of rock debris at the research depth.

2. The method for creating statistics on the content of rock debris in the conglomerate reservoir according to claim 1, wherein the step b is specifically as follows:
b1. carrying out full-borehole processing on the imaging well log to eliminate white bar parts, and smoothing;
b2. marking bright spots of the gravel in the imaging well log to obtain areas of various bright spots;
b3. adding the areas of the various bright spots to obtain a total area of the bright spots, and making a ratio of the total area of the bright spots to the total area of the imaging well log to acquire an area percentage Nrock debris (total) of the total content of gravel components.

3. The method for creating statistics on the content of rock debris in the conglomerate reservoir according to claim 1, wherein the step c is specifically as follows:
c1. obtaining the type of the gravel-grade rock debris through the rock core sample;
c2. measuring particle sizes of various kinds of gravel-grade rock debris, and calculating the area of the rock debris, specifically including processes that for an elongated rock debris particle with a ratio of a long axis length to a short axis length more than or equal to 1.5, the long and short axes of the particle are measured, and then an ellipse area formula is utilized to approximately obtain an actual area of the elongated particle, namely the area of the rock debris is Sellipse=nab, where a is the length of a semi-major axis of the rock debris particle, and b is the length of a semi-minor axis of the rock debris particle. For circular rock debris particles in case of little difference between the long and short axes of the particle, namely the ratio of the length of the long axis to the length of the short axis being greater than or equal to 1 but smaller than 1.5, the particle may be seen as a circle approximately, using the circle area formula to approximately obtain the actual area of such particle, namely the area of the rock debris is Scircle=πR2, where R is the length semi-diameter of the long axis of the rock debris particle;
c3. adding the areas of all kinds of gravel-grade rock debris to obtain the total area of rock debris Srock debris (total);
c4. classifying the areas of all measured rock debris one by one according to the types of rock debris thereof; adding the areas of various kinds of gravel-grade rock debris to obtain the total area Srock debris X of various kinds of rock debris;
c5. obtaining the area Qrock debris X=Srock debris X/Srock debris (total) of various kinds of gravel-grade rock debris.

4. The method for creating statistics on the content of rock debris in the conglomerate reservoir according to claim 2, wherein the step b2 is specifically as follows:
b2.1: converting the imaging well log into a gray image from a colorful image;
b2.2: converting the gray image into a binary image based on the brightness;
b2.3: deleting targets less than 100 pixels from the binary image; and
b2.4: finding out a bright spot boundary in the processed binary image, and calculating the areas of the various bright spots after the bright spot boundary is drawn.
